(19) United States
(12) Patent Application Publication
(10) Pub. No.: US 2024/0404565 A1
(43) Pub. Date: Dec. 5, 2024

(54) TAPE MONITORING SYSTEM

(71) Applicant: Intertape Polymer Corp., Sarasota, FL (US)

(72) Inventors: William Corbello, Sarasota, FL (US); Michael Curtin, Sarasota, FL (US)

(21) Appl. No.: 18/677,362

(22) Filed: May 29, 2024

Related U.S. Application Data
(60) Provisional application No. 63/470,030, filed on May 31, 2023.

(51) Int. Cl. G11B 27/36

(52) U.S. Cl. CPC G11B 27/36

(57) ABSTRACT

Example systems, methods, and apparatus are disclosed herein for an assembly monitoring system including an assembly, a gateway, at least one control unit, at least one sensor module, a connection hub, a sensor, an online server and database, a local monitoring device, and a remote monitoring device. The gateway transmits the display data and usage data to the online server and database. The online server and database receives the display data and usage data and to retains it. The remote monitoring device accesses the display data and usage data remotely and the local monitoring device accesses the display data and usage data locally.

### PRIORITY CLAIM AND CROSS-REFERENCE TO RELATED APPLICATIONS

The present application claims priority to U.S. Provisional Patent Application No. 63/470,030, filed on May 31, 2023, and entitled LOW TAPE MONITORING SYSTEM, the contents of which are hereby incorporated by reference in their entirety.

### BACKGROUND

Current tape monitoring systems require sensors to be physically disposed on tape heads. Existing tape sensors are often physically clunky. Sensors on tape heads can make accessing tape more difficult, making tape replacement cumbersome. Existing tape monitoring systems also face various data storage and transmission challenges. Specifically, current tape monitoring systems are mostly limited to local data storage. However, these systems often include little-to-no capabilities to communicate with third party devices, other tape monitoring systems, and data networks. Finally, current tape monitoring systems display data collected in simple manners, and fail to leverage data collected to predict user needs, such as patterns of component break downs.

Accordingly, there is a need for a tape monitoring system that implements alternative tape sensor configurations, stores system data for complex local or remote use, and that leverages data collected to make system predictions for users.

### SUMMARY

Example systems, methods, and apparatus are disclosed herein for a tape monitoring system.

In light of the disclosure herein, and without limiting the scope of the invention in any way, in a first aspect of the present disclosure, which may be combined with any other aspect listed herein unless specified otherwise, an assembly monitoring system including at least one assembly, a gateway, at least one control unit, at least one sensor module, at least one connection hub, at least one sensor, an online server and database, a local monitoring device, and a remote monitoring device. The at least one control unit is configured to receive usage data from the at least one sensor module, and the at least one control unit is configured to convert the usage data into display data. The at least one sensor module is configured to receive usage data from the at least one sensor, and wherein the at least one sensor module is configured to convert the usage data into display data. The online server and database is configured to receive usage data from the gateway, and wherein the online server and database is configured to convert the usage data into display data. The control unit is configured to transmit the display data and usage data to the gateway. The at least one sensor module is configured to transmit the display data and usage data to the control unit. The gateway is configured to transmit the display data and usage data to the online server and database. The online server and database configured to receive the display data and usage data. The online server and database is configured to retain the display data and usage data. The remote monitoring device is configured to access the display data and usage data remotely. The local monitoring device is configured to access the display data and usage data locally.

In a second aspect of the present disclosure, which may be combined with any other aspect listed herein unless specified otherwise, the case assembly includes a sealer, the at least one sensor, a connector, the at least one control unit, and the at least one connection hub. The at least one control unit controls a stack light.

In a third aspect of the present disclosure, which may be combined with any other aspect listed herein unless specified otherwise, the at least one sensor is one of a low tape sensor, a tape application sensor, a box present sensor, a top tape head sensor, a bottom tape head sensor, an entrance sensor, an exit sensor, a pressure sensor, or a photo sensor.

In a fourth aspect of the present disclosure, which may be combined with any other aspect listed herein unless specified otherwise, the at least one sensor is configured to collect usage data and the at least one sensor is configured to transmit the usage data to the sensor module via the connector. The at least one sensor module is configured to transmit the usage data to the at least one connection hub.

In a fifth aspect of the present disclosure, which may be combined with any other aspect listed herein unless specified otherwise, the at least one connection hub transmits the usage data to the at least one control unit, and the at least one control unit transmits the usage data to the gateway.

In a sixth aspect of the present disclosure, which may be combined with any other aspect listed herein unless specified otherwise, the at least one control unit is configured to command the stack light to display a given light color combination and lighting frequency based on the usage data.

In a seventh aspect of the present disclosure, which may be combined with any other aspect listed herein unless specified otherwise, the at least one assembly is one of void fill assemblies, pillow film assemblies, case packer assemblies, cartoners, water activated tape dispenser assemblies, and shrink equipment assemblies.

In an eight aspect of the present disclosure, which may be combined with any other aspect listed herein unless specified otherwise, the gateway is configured to apply an algorithm to the usage data, where the algorithm identifies patterns in the usage data, and where the algorithm prepares a preventative maintenance alert in the form of display data.

In a ninth aspect of the present disclosure, which may be combined with any other aspect listed herein unless specified otherwise, the local monitoring device is one of a computer screen, display screen, monitor, or touch screen.

In a tenth aspect of the present disclosure, which may be combined with any other aspect listed herein unless specified otherwise, the remote monitoring device is one of a mobile phone, a tablet, a laptop computer, or a handheld device with internet connection.

In an eleventh aspect of the present disclosure, which may be combined with any other aspect listed herein unless specified otherwise, a case sealer assembly including a sealer, at least one sensor, a connector, a control unit that controls a stack light, sensor module, and a connection hub. The at least one sensor is configured to collect usage data, the at least one sensor is configured to transmit the usage data to the sensor module via the connector, and the sensor module is configured to transmit usage data to the control unit via the connection hub.

In a twelfth aspect of the present disclosure, which may be combined with any other aspect listed herein unless specified otherwise, the at least one sensor is one of a low tape sensor, a tape application sensor, a box present sensor, a top tape head sensor, a bottom tape head sensor, an entrance sensor, an exit sensor, a pressure sensor, or a photo sensor.

In a thirteenth aspect of the present disclosure, which may be combined with any other aspect listed herein unless specified otherwise, the control unit is configured to command the stack light to display a given light color combination and lighting frequency based on the usage data.

In a fourteenth aspect of the present disclosure, which may be combined with any other aspect listed herein unless specified otherwise, the control unit is configured to transmit the usage data to a gateway.

In a fifteenth aspect of the present disclosure, which may be combined with any other aspect listed herein unless specified otherwise, the gateway is configured to receive usage data from the control unit, and the gateway is configured to convert the usage data into display data.

In a sixteenth aspect of the present disclosure, which may be combined with any other aspect listed herein unless specified otherwise, the gateway is configured to apply an algorithm to the usage data, the algorithm identifies patterns in the usage data, and the algorithm prepares a preventative maintenance alert in the form of display data.

In a seventeenth aspect of the present disclosure, which may be combined with any other aspect listed herein unless specified otherwise, a method of monitoring an assembly monitoring system, the assembly monitoring system including at least one assembly, a gateway, a sensor module, a control unit, an online server and database, a local monitoring device, and a remote monitoring device. The method including receiving usage data from the at least one assembly, converting the usage data into display data in one of the control unit or the sensor module, transmitting the display data and the usage data from the control unit or sensor module to the gateway, receiving the display data and usage data in the gateway, transmitting the display data and the usage data from the gateway to the online server and database, retaining a copy of the display data and usage data in the online server and database, accessing the display data and usage data on the online server and database through the remote monitoring device, and accessing the display data and usage data on the online server and database through the local monitoring device.

In an eighteenth aspect of the present disclosure, which may be combined with any other aspect listed herein unless specified otherwise, further including applying an algorithm to the usage data, where the algorithm identifies patterns in the usage data, and where the algorithm prepares a preventative maintenance alert in the form of display data.

In a nineteenth aspect of the present disclosure, which may be combined with any other aspect listed herein unless specified otherwise, the at least one assembly is one of void fill assemblies, pillow film assemblies, case packer assemblies, cartoners, water activated tape dispenser assemblies, and shrink equipment assemblies.

In a twentieth aspect of the present disclosure, which may be combined with any other aspect listed herein unless specified otherwise, the usage data is one of low tape, tape changes per day, tape not applied to carton, tape not cut, box jams, downstream stoppage, carton sealer excess runtime with no processed packages, approximate box length, process time, time stamp for every box, system start-up and shut-down times, cartons processed per minute/day, and carton sealer running time and off time.

In a twenty-first aspect of the present disclosure, any of the structure, functionality, and alternatives disclosed in connection with any one or more of FIGS. 1 to 5 may be combined with any other structure, functionality, and alternatives disclosed in connection with any other one or more of FIGS. 1 to 5.

In light of the present disclosure and the above aspects, it is therefore an advantage of the present disclosure to provide users with a tape monitoring system and a method of displaying data from a tape monitoring system.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1 is a diagram view of a tape monitoring system, according to an example embodiment of the present disclosure.

FIG. 2 is perspective view of a case sealer assembly, according to an example embodiment of the present disclosure.

FIGS. 3 to 5 illustrate various screen views of a graphical user interface for a tape monitoring system, according to example embodiments of the present disclosure.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specific the presence of stated features, integers, steps, operations, elements, and/or components, but do not preclude the presence or additional of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent”). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Methods, systems, and apparatus are disclosed herein for a tape monitoring system.

While the example methods, apparatus, and systems are disclosed herein as a tape monitoring system, it should be appreciated that the methods, apparatus, and systems may be operable with other materials such as unfolded carton boxes.

### System

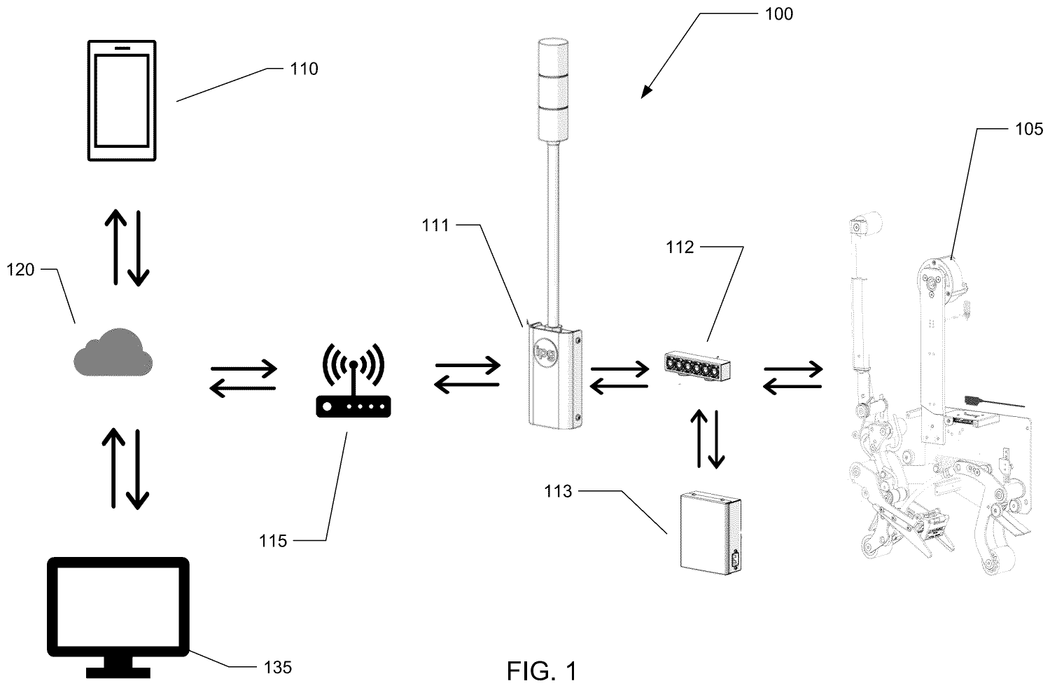

FIG. 1 illustrates a diagram view of a tape monitoring system, referred to as “the system”. The system 100 includes a case sealer assembly 105, a gateway 115, an online server/database 120, a connection hub 112, a sensor module 113, a control unit 111, a local monitoring device 135, and a remote monitoring device 110.

The case sealer assembly 105 is wirelessly linked with the connection hub 112 via, for example, a modbus protocol. The sensor module 113 is also coupled to the connection hub 112 via, for example, a modbus protocol. Finally, the connection hub 112 is coupled to the control unit 111 via, for example, a modbus protocol. The control unit 111 is concurrently coupled via, for example, LoRa or WiFi to the gateway 115. It should be noted that the connections protocols connecting the various components of the system 100 can vary in alternate embodiments.

The case sealer assembly 105 locally collects usage data, via the sensor module 113, and transmits the usage data to the control unit 111. The usage data can include, but is not limited to, low tape, non-cut tape, processing time, carton jams, downstream stoppage, downstream jams, rolls of tape changed, packages processed per minute, machine status, tape speed, and processing overall.

Upon receiving the usage data, the control unit 111 processes the usage data and applies a working algorithm to convert the usage data into display data. As noted, the control unit 111 is coupled to the gateway 115. The gateway 115 is coupled to the online server/database 120 via, for example, GSM/LAN. In turn, the gateway 115 subsequently transmits the display data to the online server/database 120. The online server/database 120 is coupled to the local monitoring device 135 and the remote monitoring device 110 via an internet connection.

The online server/database 120 then transmits the display data to the local monitoring device 135 and retains the display data in a “cloud” location. Alternatively, the online server/database 120 can transmit the display data using a GSM connection, or another communication protocol.

Users can access the display data from the online server/database 120 using a remote monitoring device 110. Display data is transmitted using MQTT (known as Mosquitto): Publish/Subscribe. As such, a flag is set when display data is transmitted to the online server/database 120 and if a ‘data received notification’ is not transmitted, the display data will be resent until a verification notice is sent or a timeout is reached. A log will be saved to the local monitoring device 135 with time stamps for data transmit errors. Also, a 4g/5G router is attached to the system 100 for remote data transmitting to the online server/database 120 for viewing using a remote monitoring device 110.

The display data is displayed on the remote monitoring device 110 and the local monitoring device 135 via a graphical user interface, further detailed below. As such, the remote monitoring device 110 allows users to monitor the system 100 from outside the facility.

Examples of remote monitoring devices 110 include, but are not limited to, smart cellphones, tablets, or laptop computers, or other devices with internet access. The local monitoring device 135 includes, for example, a display screen, or another device locally connected to the online server/database 120.

While this embodiment includes a case sealer assembly 105, alternate embodiments may include, but is not limited to, for example, void fill assemblies, pillow film assemblies, case packer assemblies, cartoners, water activated tape dispenser assemblies, shrink equipment assemblies, or other types of automated packaging solutions.

Additionally, while this embodiment includes a single case sealer assembly 105, it should be noted that the system 100 is modular. As such, the system 100 is configured to include a plurality of case sealer assemblies 105. Moreover, the system 100 can include various different combinations of assemblies. The assemblies connect to the gateway 115 using LoRa radio to transmit usage data across a facility, for example, without repeaters. While this embodiment uses LoRa radio, other suitable communication technologies for long range connection and communication may be utilized.

Connections of components in the system 100 can vary. First, direct Wi-Fi connection to the gateway 115 is available through Access Point (AP) (SSID) connection (phone or computer), where AP is used for initial setup, and where this connection allows adjustment of settings and options of the assemblies 105. Next, standard WLAN Wi-Fi connection, which allows for assemblies 105 to share a Wi-Fi router. If using WLAN, the remote monitoring device 110 can be setup in a Mesh configuration where each unit can retransmit data from units further away. Finally, LoRa WAN connection can be used for systems spaced out in larger facilities (915MHZ transmitters).

Relatedly, AP Mode (Access Point) is used to directly connect to individual systems 100 for initial settings, such as IP address, top and bottom mandrel speed settings for low tape, top and bottom timeout settings for no tape, conveyor belt speed distance from carton detection photoeye an exit photoeye, and jam detection time. Station Mode is used to directly connect to Data Acquisition Computer (Server). Any Wi-Fi equipped device can directly connect to the Server or system. A cellular router can be used to upload data to cloud or for remote viewing. Moreover, for Access Point connection (in AP Mode), the user will need the SSID for each system along with the password to connect, and use the IP Address: 192.168.4.1. For Server Connection (in Station Mode), the user will need the SSID for the Router along with the password for connection. The user will need a name and a password is needed to access a Dashboard, and will use IP Address: 192.168.10.199.

The system 100 captures a variety of data through the use of sensors 107. For example, the system may capture data on tape head errors, such as low tape needing changing soon, tape changes per day, tape not applied to carton, or tape not cut. The system 100 may also capture data on carton sealer errors, such as carton did not process correctly (box jam), carton did not exit sealer (downstream stoppage), and carton sealer excess runtime with no processed packages. The system 100 may also capture box data, such as approximate box length (based on conveyor speed and how long the box broke the carton entry photosensor), process time (from entry to exit), and time stamp for every box. Finally, the system 100 may capture running data, such as system start-up and shut-down times, cartons processed per minute/day, and carton sealer running time and off time.

### Assemblies in the System

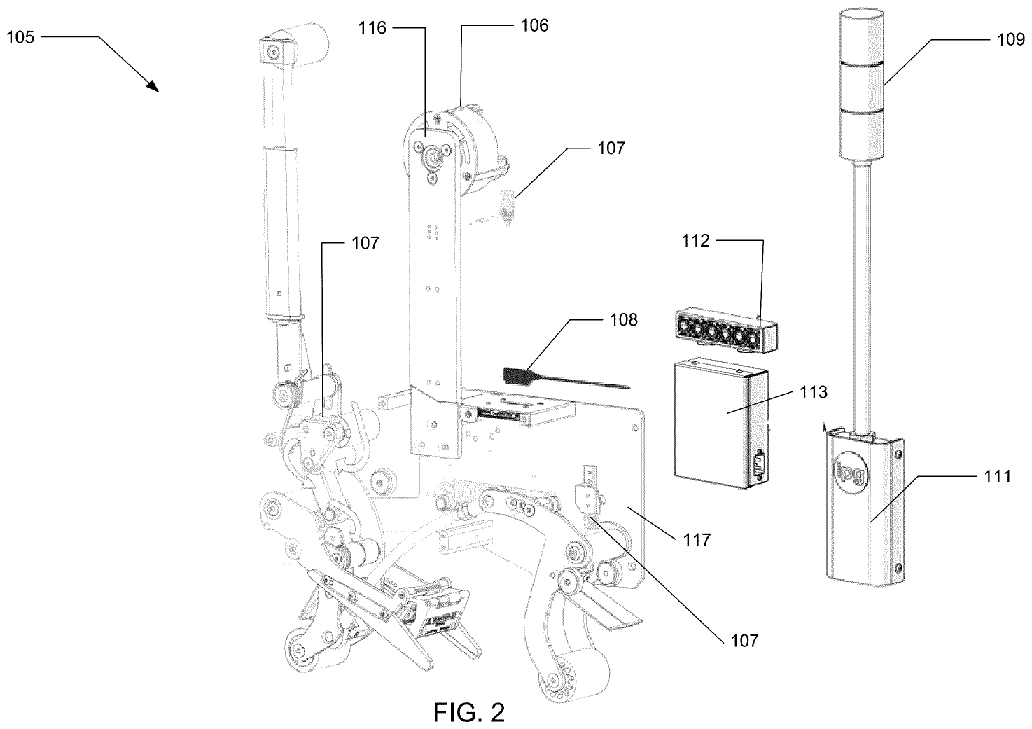

FIG. 2 illustrates a perspective view of a case sealer assembly. As illustrated, the case sealer assembly 105 includes a sealer 106, sensors 107, a connector 108, a control unit 111, a stack light 109, a sensor module 113, and a connection hub 112. In this embodiment, the connector 108 is magnetic, but in alternate embodiments the connector 108 may be a wired connector.

In this embodiment, there is a plurality of sensors 107 on the sealer 106. For example, a tape head 116 may include a low tape sensor. Other sensors 107 on the sealer 106 may include a tape application sensor, a box present sensor, a top tape head sensor, a bottom tape head sensor, an entrance sensor, an exit sensor, or another type of sensor. Specifically, for example, a clutch rotation proximity sensor may be used as a no tape, no cut sensor. A photo sensor for the tape roll diameter may be used as a low tape sensor. A photo sensor for tape head application roller depression may be used as a box in motion sensor. The sensors 107 are disposed separate from other moving components of the sealer 106. For example, top tape head sensor, bottom tape head sensor, entrance sensor, and exit sensor are not affixed to other moving components, such as a conveyor belt or the tape head 116.

The sealer 106 is selectively coupled to the sensor module 113 via the connector 108. As such, the information collected by the sensors 107 is also connected with the sensor module 113. The sealer 106 is further connected to the control unit 111 via the connection hub 112. Specifically, each case sealer assembly 105 includes a single connection hub 112 and sensor module 113. As such, the number of connection hubs 112 and sensor modules 113 in the system 100 is directly proportional to the number of assemblies 105 in the system 100. Each sensor module includes Micro Controller on a control board with a connection to the sensors 107 on the sealer 106.

The connection hub 112 acts in the same way as an internet switch in networking. That is, the connection hub 112 uses RJ ethernet cables to distribute 24V power, usage data from the sensors, and communications between the components of the system 100. Regarding the sensor module 113, the sensor module 113 is connected to an electric power source and provides the 24V power that is distributed by the connection hub 112. The sensor module 113 further includes a 20-amp rated socket into which the sealer 106 is connected for electric power. Finally, the sensor module 113 is connected to the gateway 115 to transmit all usage data from the sensors. The usage data from the sensors 107 is transmitted to the sensor module 113 and the control unit 111, concurrently, through a wired connection or wirelessly through protocols such as, but not limited to, modbus network, LoRaWAN, or WiFi. Notably, each sensor 107 includes a unique identifier in the usage data collected. As such, usage data from the sensors 107 is directly traced to the assembly 105 from which it stems. In turn, this further enables the system 100 to include multiple assemblies 105 for which usage data is presented in a graphical user interface, as further detailed below.

The sensor module 113 receives usage data from the sensors 107 and is configured to momentarily interrupt power to the sealer 106, to stop the sealer belts, when it receives an error message from the sensors 107. The momentary power interruption allows for non-destructive integration into pressure sensitive sealers 106. Relatedly, the control unit 107 can also be configured to interrupt power to the sealer 106, to stop the sealer belts, when it receives a specified usage data combination from the sensors 107, via the sensor module 113. For example, the control unit can momentarily shut down power to the sealer 106 when no packages are being processed, for a set time, and automatically stop package processing, to prevent sealer 106 wear.

The control unit 111 is configured to receive usage data from the sensors 107 via the sensor module 113. The control unit 111 is further configured to control the stack light 109. Specifically, in this embodiment, the stack light 109 includes a set of green, yellow, and red lights. The control unit 111 controls the specific lights activated and the length of activation, in accordance with various sealer 106 status indicators based on the usage data from the sensors 107.

Specifically, in the present embodiment: a solid green light denotes the sealer 106 is powered on and operating under nominal conditions, a slowly blinking green denotes the sealer 106 is idle, belts off, and waiting to be activated; a slowly blinking yellow light denotes the sealer 106 is registering low tape for one or more tape heads; a solid red light denotes the sealer 106 is off and not running; a quickly blinking red light denotes the sealer 106 is registering a tape error and has stopped the machine; slowly blinking with of the red, yellow, and green lights denotes the sealer 106 is in bypass mode, such that no errors will be detected and the control unit 111 will not stop the sealer 106; and quickly blinking with red and yellow lights denotes the sealer 106 is detecting an error and to resolve the error the user must press a “Scan Button” to reset the sealer 106.

Relatedly, the user can activate a scanning feature on the sealer 106. In this feature, the user presses the “Scan Button” and the system 100 checks for all items connected to the gateway 115 will check for all items connected to the system. Once the scan has been completed the stack light indicator will briefly indicate how the system is set up. In this case, a solid green light detects a bottom tape head only configuration, a solid yellow light detects both top and bottom tape heads, and a solid red light detects a top tape head only configuration.

It should be noted that the number, color, and combination of lights may vary by embodiments. Moreover, alternate embodiments can include audible or user graphical interface notifications, such as pop-up messages. The system 100 can further send alerts to the user via email.

As an example of the above features, in this embodiment, the system 100 may monitor the assembly 105 for low tape. In this example, a carton enters the tape application area on conveyor of the sealer 106. The tape head sensors 107 pick up rotational speed from mandrel as tape is applied to carton. If the rotation speed is above a user selectable value the yellow stack light 109 illuminates to indicate that a tape roll change is needed (faster rotation for smaller rolls of tape). The green stack light 109 remains illuminated. A reset push button indicator remains illuminated. Finally, changing the tape roll will initiate a slower rotation speed, which will extinguish the yellow stack light indicator 109.

In an additional embodiment, the system 100 may monitor for carton jams. For example, a carton enters the tape application area on the conveyor of the sealer 106. The carton entry sensor 107 starts a processing timer based on the speed of equipment conveyors (user selectable). If carton does not exit the conveyor before the timer finishes, dry contact relay turns on for 0.3 seconds which acts as E-Stop dropping out 24 VDC running relay (stops equipment), the interlock digital output turns off, the green light stack 109 turns off, the reset push button indicator light turns off, the red light stack 109 blinks at a rate of once per second, and the buzzer (user selectable to turn off) emits 85 db sound. The alarm can be silenced by pushing the equipment Start button, Reset button on the system, or a Remote reset button station (optional with running indicator). This action will start equipment running.

In an embodiment, the system 100 monitors various parameters. For example, a real time clock on each assembly 105 allows for proper time settings. Usage data transmitted from the assemblies 105 is stored in a MySQL database on the a server/database 120. Every time the assembly 105 is started a time stamp is sent with the assembly's name and start time. Periodically the gateway 115 transmits the assembly's name, average cartons per minute and total cartons processed. If a ‘No Tape’ or jam detection occurs, the gateway 115 transmits the system name, time, and the error detected. When an assembly 105 is reset, a time stamp is sent with the assembly's name and restart time. Uptime and downtime can be easily pulled for the system. If a low tape situation is sensed, a onetime message is sent with the assembly's name, time of occurrence and whether it was the top or bottom tape head. Once the tape is replaced a similar transmission is made acknowledging the roll change.

### Graphical User Interface

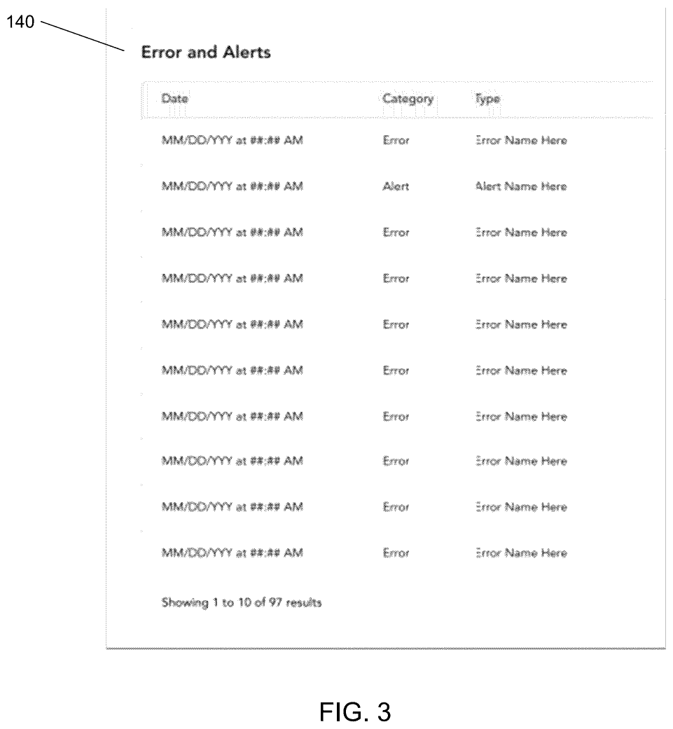

FIGS. 3 to 5 illustrate various screen views of a graphical user interface for a tape monitoring system. It should be appreciated that display data depicted in FIGS. 3 to 5 is displayed, to the user, via the local monitoring device 135 or the remote monitoring device 110. Specifically, the graphical user interface may include a login screen. Once logged in, the user can access various user interface screens (FIGS. 3 to 5), either locally 135 or remotely 110.

Regarding the display data, any one of the sensor module 113, control unit 111, or online server/database 120 receives usage data from the sensors 107 and then applies various algorithms. The algorithms analyze usage data from the sensors to determine patterns in all the parameters measured by the sensors. The algorithms then further use the patterns determined in order to create predictions on future maintenance needs. In turn, the algorithm returns a preventative maintenance alert in the form of display data and/or user alerts in the form of emails. As such, the display data presented to the user is not only real-time data, but also dynamic predictive data. FIG. 3 shows an example of the graphical user interface for an error log 140. The error log 140 is what the algorithms analyze to determine patterns and make predictions. In an alternate embodiment, the algorithms are applied to usage data at the gateway 115.

In way of example, the type of preventative maintenance alerts may include imminent roll change, or isolate problematic equipment and/or operators based on down time and throughput.

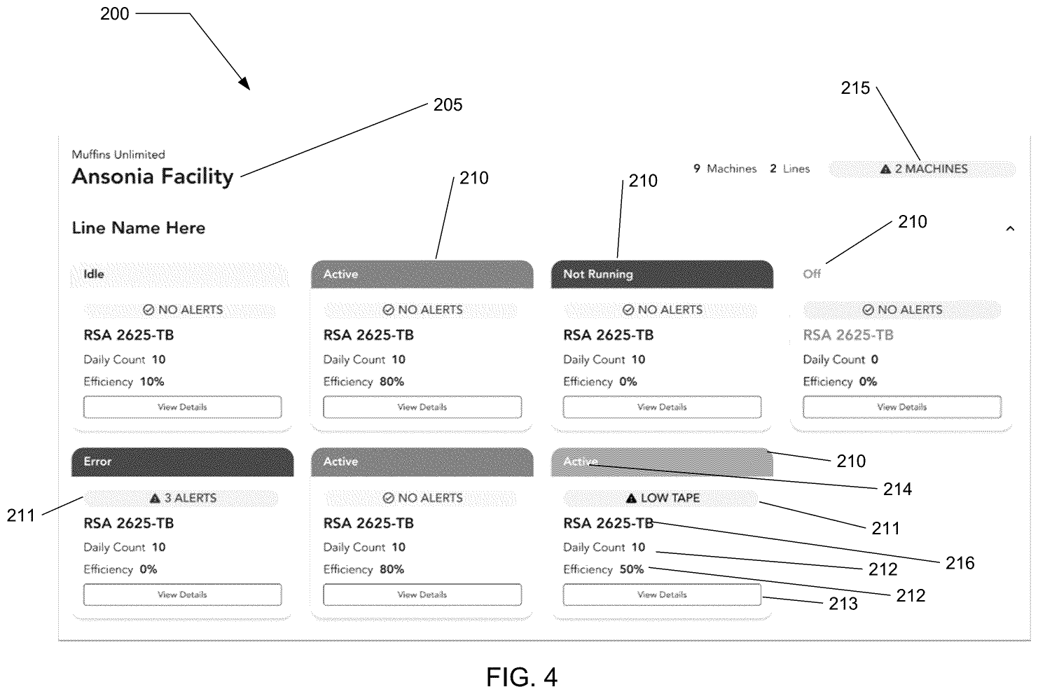

FIG. 4 shows screen view of a graphical user interface for a tape monitoring system for a facility including various assemblies. The facility-wide view 200 shows a user-defined facility name 205, various assembly modules 210, and an alert field 215. The alert field 215 displays the name and type of action needed for any assemblies whose usage data indicates an error. Additionally, the alert field 215 may also be the location where preventative maintenance alerts are displayed.

The various assembly modules 210 correspond with individual assemblies 105 that are part of the system 100. Each assembly module 210 provides a general overview of the relevant assembly 105 monitored by the system 100. Specifically, the assembly module 210 includes the assembly name/identifier 216, a general activity field 214 that denotes whether the assembly 105 is running or not, and various use parameters 212. The use parameters 212 can vary and be modified by the user. Each assembly module 210 can be a different color to denote assembly status. For example, a green module 210 can denote the assembly 105 is running, a yellow module 210 can denote an assembly 105 that is running but has an alert, and a red module 210 can denote an assembly that is not running. Finally, each assembly module 210 includes a selectable “view details” field 213. The user can select the “view details” field 213 to access a detailed view of the respective assembly's usage data

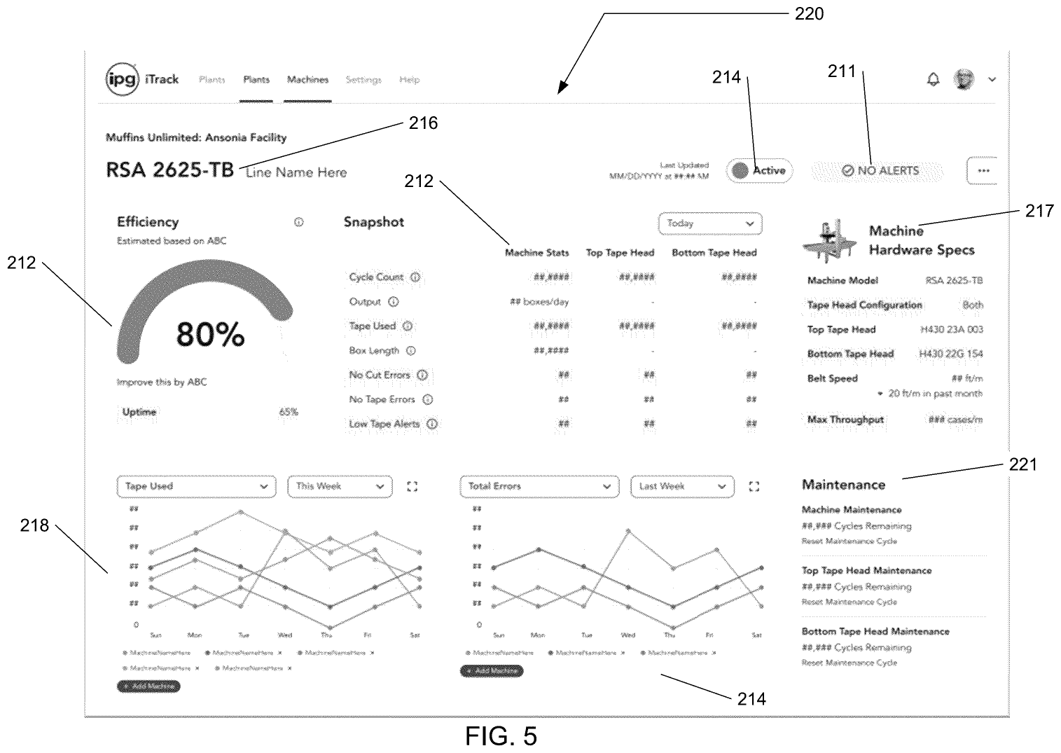

FIG. 5 shows screen view of a graphical user interface for a tape monitoring system for a detailed view of an individual assembly in a facility. The detailed view 220 shows the assembly name/identifier 216, the general activity field 214, and various parameters 212. Moreover, the detailed view 220 shows specifics of the assembly hardware 217, preventative maintenance information 221 based on the algorithms, and dynamic assembly activity graphs 218. As such, the user can access the detailed view 220, from the local monitoring device 135 or the remote monitoring device 110, to get a real-time snapshot of each respective assembly 105, while also getting insight into potential upcoming maintenance issues.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An assembly monitoring system, the system comprising:
at least one assembly;
a gateway;
at least one control unit;
at least one sensor module;
at least one connection hub;
at least one sensor;
an online server and database;
a local monitoring device; and
a remote monitoring device;
wherein the at least one control unit is configured to receive usage data from the at least one sensor module, and wherein the at least one control unit is configured to convert the usage data into display data;
wherein the at least one sensor module is configured to receive usage data from the at least one sensor, and wherein the at least one sensor module is configured to convert the usage data into display data;
wherein the online server and database is configured to receive usage data from the gateway, and wherein the online server and database is configured to convert the usage data into display data;
wherein the control unit is configured to transmit the display data and usage data to the gateway;
wherein the at least one sensor module is configured to transmit the display data and usage data to the control unit;
wherein the gateway is configured to transmit the display data and usage data to the online server and database;
wherein the online server and database configured to receive the display data and usage data;
wherein the online server and database is configured to retain the display data and usage data;
wherein the remote monitoring device is configured to access the display data and usage data remotely; and
wherein the local monitoring device is configured to access the display data and usage data locally.

2. The system of claim 1, wherein the at least one assembly is a case assembly, wherein the case assembly is comprised of a sealer, the at least one sensor, a connector, the at least one control unit, and the at least one connection hub, and wherein the at least one control unit controls a stack light.

3. The system of claim 2, wherein the at least one sensor is one of a low tape sensor, a tape application sensor, a box present sensor, a top tape head sensor, a bottom tape head sensor, an entrance sensor, an exit sensor, a pressure sensor, or a photo sensor.

4. The system of claim 2, wherein the at least one sensor is configured to collect usage data and wherein the at least one sensor is configured to transmit the usage data to the at least one sensor module via the connector, and wherein the at least one sensor module is configured to transmit the usage data to the at least one connection hub.

5. The system of claim 4, wherein the at least one connection hub transmits the usage data to the at least one control unit, and wherein the at least one control unit transmits the usage data to the gateway.

6. The system of claim 4, wherein the at least one control unit is configured to command the stack light to display a given light color combination and lighting frequency based on the usage data.

7. The system of claim 1, wherein the at least one assembly is one of void fill assemblies, pillow film assemblies, case packer assemblies, cartoners, water activated tape dispenser assemblies, and shrink equipment assemblies.

8. The system of claim 1, wherein the gateway is configured to apply an algorithm to the usage data, wherein the algorithm identifies patterns in the usage data, and wherein the algorithm prepares a preventative maintenance alert in the form of display data.

9. The system of claim 1, wherein the local monitoring device is one of a computer screen, display screen, monitor, or touch screen.

10. The system of claim 1, wherein the remote monitoring device is one of a mobile phone, a tablet, a laptop computer, or a handheld device with internet connection.

11. A case sealer assembly, the assembly comprising:
a sealer;
at least one sensor;
a connector;
a control unit that controls a stack light;
sensor module; and
a connection hub;
wherein the at least one sensor is configured to collect usage data, wherein the at least one sensor is configured to transmit the usage data to the sensor module via the connector, and wherein the sensor module is configured to transmit usage data to the control unit via the connection hub.

12. The assembly of claim 11, wherein the at least one sensor is one of a low tape sensor, a tape application sensor, a box present sensor, a top tape head sensor, a bottom tape head sensor, an entrance sensor, an exit sensor, a pressure sensor, or a photo sensor.

13. The assembly of claim 11, wherein the control unit is configured to command the stack light to display a given light color combination and lighting frequency based on the usage data.

14. The assembly of claim 11, wherein the control unit is configured to transmit the usage data to a gateway.

15. The assembly of claim 14, wherein the gateway is configured to receive usage data from the control unit, and wherein the gateway is configured to convert the usage data into display data.

16. The system of claim 15, wherein the gateway is configured to apply an algorithm to the usage data, wherein the algorithm identifies patterns in the usage data, and wherein the algorithm prepares a preventative maintenance alert in the form of display data.

17. A method of monitoring an assembly monitoring system, the assembly monitoring system comprising at least one assembly, a gateway, a sensor module, a control unit, an online server and database, a local monitoring device, and a remote monitoring device, the method comprising:
receiving usage data from the at least one assembly;
converting the usage data into display data in one of the control unit or the sensor module;
transmitting the display data and the usage data from the control unit or sensor module to the gateway;
receiving the display data and usage data in the gateway;
transmitting the display data and the usage data from the gateway to the online server and database;
retaining a copy of the display data and usage data in the online server and database;
accessing the display data and usage data on the online server and database through the remote monitoring device; and
accessing the display data and usage data on the online server and database through the local monitoring device.

18. The method of claim 17, further comprising applying an algorithm to the usage data, wherein the algorithm identifies patterns in the usage data, and wherein the algorithm prepares a preventative maintenance alert in the form of display data.

19. The method of claim 17, wherein the at least one assembly is one of void fill assemblies, pillow film assemblies, case packer assemblies, cartoners, water activated tape dispenser assemblies, and shrink equipment assemblies.

20. The method of claim 17, wherein the usage data is one of low tape, tape changes per day, tape not applied to carton, tape not cut, box jams, downstream stoppage, carton sealer excess runtime with no processed packages, approximate box length, process time, time stamp for every box, system start-up and shut-down times, cartons processed per minute/day, and carton sealer running time and off time.
